(19) United States
(12) Patent Application Publication
(10) Pub. No.: US 2012/0011522 A1
(43) Pub. Date: Jan. 12, 2012

(54) Motor and optical disc drive using the same

(75) Inventors: Dong Woo Rhee, Yongin (KR); Jun Kyu Park, Seoul (KR); Jae Yoon Kim, Suwon (KR)

(73) Assignee: SAMSUNG ELECTRO-MECHANICS CO., LTD, Suwon (KR)

(21) Appl. No.: 13/067,661

(22) Filed: Jun. 17, 2011

(30) Foreign Application Priority Data
Jul. 6, 2010 (KR) 10-2010-0064913

(51) Int. Cl. G11B 17/028; H02K 5/167

(52) U.S. Cl. 720/695; 310/425; G9B/17.006

(57) ABSTRACT

There is provided a motor and an optical disc drive using the same, more particularly, a motor having an improved coupling structure between a rotor and a stator, and an optical disc drive using the same. The motor includes: a shaft; a sleeve supporting the shaft so as to be rotatable; a stator coupled to an outer circumferential surface of the sleeve and extended outwardly in an outer diameter direction of the sleeve; and a base plate coupled to the outer circumferential surface of the sleeve under the stator and supporting the stator.

### CROSS-REFERENCE TO RELATED APPLICATIONS

This application claims the priority of Korean Patent Application No. 10-2010-0064913 filed on Jul. 6, 2010, in the Korean Intellectual Property Office, the disclosure of which is incorporated herein by reference.

### BACKGROUND OF THE INVENTION

1. Field of the Invention

The present invention relates to a motor and an optical disc drive using the same, and more particularly, to a motor having an improved coupling structure between a rotor and a stator, and an optical disc drive using the same.

2. Description of the Related Art

Generally, a spindle motor mounted in an optical disc drive serves to rotate a disk so that an optical pickup mechanism can read data recorded on the disc.

In a spindle motor according to the related art, a base plate has a circuit board mounted thereon and a sleeve holder fixed thereto at a center part thereof, the sleeve holder having a core coupled thereto.

However, in the case of the motor including the sleeve holder according to the relate art, a method of coupling the sleeve holder and the base plate to each other through a separate coupling process such as a spinning process, a caulking process, or the like, has been used. This separate coupling process may cause an increase in the total number of required processes, resulting in the deterioration of productivity.

### SUMMARY OF THE INVENTION

An aspect of the present invention provides a motor in which the structure and manufacturing process thereof may be simplified by improving a coupling structure between a rotor and a stator, and an optical disc drive using the same.

According to an aspect of the present invention, there is provided a motor including: a shaft; a sleeve supporting the shaft so as to be rotatable; a stator coupled to an outer circumferential surface of the sleeve and extended outwardly in an outer diameter direction of the sleeve; and a base plate coupled to the outer circumferential surface of the sleeve under the stator and supporting the stator.

The base plate may include a sleeve contact part protruding upwardly along the outer circumferential surface of the sleeve and supporting the stator.

The motor may further include a support plate supporting the shaft under the shaft, wherein the support plate is press-fitted to the base plate to thereby be coupled thereto.

The support plate may have an outer circumferential surface coupled to an inner circumferential surface of the sleeve contact part of the base plate.

The sleeve contact part may have an L-shaped protruded cross section.

The sleeve contact part may have a block shaped protruded cross section.

The base plate may include a support part supporting the shaft under the shaft, and the support part may be formed as a groove formed by the sleeve contact part.

The stator may include: a core formed by stacking a plurality of steel plates, contacting the outer circumferential surface of the sleeve, and extended in the outer diameter direction of the sleeve; and a winding coil wound around the core, wherein the core may include an extension contact part being extended and bent so that at least one steel plate contacts the outer circumferential surface of the sleeve.

The extension contact part may be formed using a steel plate disposed at an uppermost layer among the steel plates forming the core.

The motor may further include a rotor receiving the stator and press-fitted to the shaft to thereby be fixed thereto; and an attraction magnet coupled to an outer circumferential surface of the extension contact part and attracting the rotor using magnetic force.

The extension contact part may have a height the same as that of the attraction magnet.

The extension contact part may have a height lower than that of the attraction magnet.

The extension contact part may have a height higher than that of the attraction magnet.

According to another aspect of the present invention, there is provided an optical disc drive including: the motor as described above; and an optical pickup mechanism mounted to be movable in a space below a disc loaded on the motor and receiving data from the disc.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor according to an exemplary embodiment of the present invention;

FIG. 2 is a schematic cross-sectional view showing a motor according to another exemplary embodiment of the present invention;

FIG. 3 is a schematic cross-sectional view showing a motor according to another exemplary embodiment of the present invention;

FIG. 4 is a schematic cross-sectional view showing a motor according to another exemplary embodiment of the present invention;

FIG. 5A is an enlarged view of an extension contact part of FIG. 4;

FIGS. 5B through 5D are views showing extension contact parts according to exemplary embodiments of the present invention; and

FIG. 6 is a schematic cross-sectional view showing an optical disc drive according to an exemplary embodiment of the present invention.

### DETAILED DESCRIPTION OF THE PREFERRED EMBODIMENT

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to most appropriately describe the best method he or she knows for carrying out the invention. Therefore, the configurations described in the embodiments and drawings of the present invention are merely the most preferable embodiments but do not represent all of the technical spirit of the present invention. Thus, the present invention should be construed as including all the changes, equivalents, and substitutions included in the spirit and scope of the present invention at the time of the filing of this application.

Hereinafter, exemplary embodiments of the present invention will be described in detail with reference to the accompanying drawings. At this time, it is noted that like reference numerals denote like elements in appreciating the drawings. Moreover, detailed descriptions related to well-known functions or configurations will be ruled out in order not to unnecessarily obscure the subject matter of the present invention. Based on the same reason, it is to be noted that some components shown in the drawings are exaggerated, omitted or schematically illustrated, and the size of each component does not exactly reflect its real size.

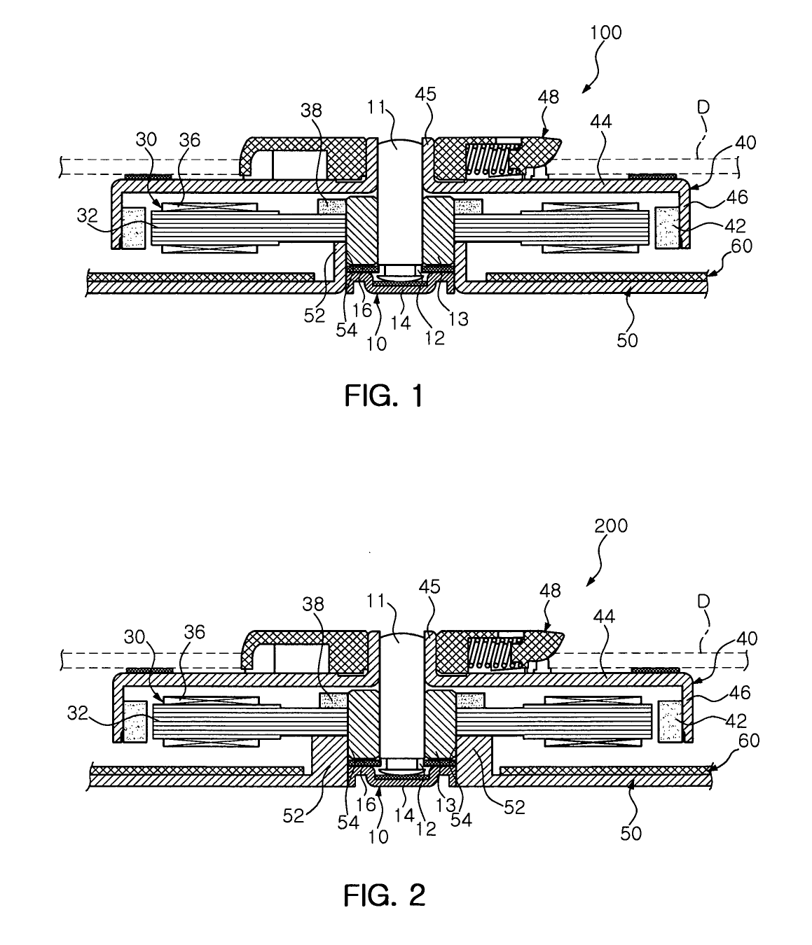

Meanwhile, terms relating to directions will be defined. As viewed in FIG. 1, an axial direction refers to a vertical direction based on a shaft 11, an outer diameter or inner diameter direction refers to a direction towards an outer edge of a rotor 40 based on the shaft 11 or a direction towards the center of the shaft 11 based on the outer edge of the rotor 40.

FIG. 1 is a schematic cross-sectional view showing a motor according to an exemplary embodiment of the present invention.

Referring to FIG. 1, a motor 100 according to the present embodiment, which is a spindle motor 100 included in an optical disc drive rotating a disc D, is configured to include a bearing assembly 10, a base plate 50, a circuit board 60, a stator 30, and a rotor 40.

The bearing assembly 10 includes the shaft 11, a sleeve 13 supporting the shaft 11, and a support plate 14 supporting the shaft 11 and the sleeve 13.

The shaft 11 may be a rotational axis of the rotor 40 to be described below. The shaft 11 according to the present embodiment includes a coupling groove 12 preventing the shaft 11 from being separated from the sleeve 13 due to the high speed rotation of a rotor case 44 to be described below. The coupling groove 12 will be described in more detail through a stopper ring 16 to be described below.

The sleeve 13 has the shaft 11 inserted into a hole formed therein, is a rotation support member having an oil film formed between the sleeve 13 and the shaft 11 so that the shaft 11 may be easily rotated and supporting the shaft 11, and serves as a bearing.

The support plate 14 is disposed under the shaft 11 and the sleeve 13 and supports the shaft 11. The support plate 14 according to the present embodiment has an outer circumferential surface press-fitted to an inner circumferential surface of a sleeve contact part 52 of the base plate 50 to be described below, that is, a coupling hole 54, to thereby be coupled to the base plate 50.

Meanwhile, the support plate 14 and the shaft 11 according to the present embodiment have a stopper ring 16 interposed therebetween. The stopper ring 16 has an annular flat ring shape and is interposed between the support plate 14 and the shaft 11 so that it is partially inserted into the coupling groove 12 of the shaft 11. The stopper ring 16 serves to prevent the shaft 11 from being separated and floated from the sleeve 13 during the high speed rotation of the rotor 40.

The base plate 50, which is a support entirely supporting other components of the motor 100, is fixedly coupled to the above-mentioned sleeve 13, and has the circuit board 60 coupled to one surface thereof.

In the present invention, the base plate 50 directly supports the stator 30 to be described below and is fixedly coupled to the sleeve 13. To this end, the base plate 50 according to the exemplary embodiment of the present invention has a plate shape and includes a coupling hole 54 and a sleeve contact part 52 formed therein.

The coupling hole 54, which is a hole having the sleeve 13 and the support plate 14 inserted thereinto to thereby be coupled thereto, has a chamfered inner circumferential surface.

The sleeve contact part 52 supports the stator 30, while being coupled to an outer circumferential surface of the sleeve 13 under the stator 30. The sleeve contact part 52 according to the present embodiment is formed to protrude upwardly along the outer circumferential surface of the sleeve 13, and has an “L” shaped cross section. Therefore, a distal end of the sleeve contact part 52 supports the stator 30 while contacting a lower surface of the stator 30. The sleeve contact part 52 according to the present embodiment may be formed by extending a base plate according to the relate art in a center direction of the coupling hole 54 and then performing a processing method such as a bending method, or the like. Therefore, the entirity of the base plate 50 including the sleeve contact part 52 has the same thickness. However, the present invention is not limited thereto. The base plate 50 according to the present embodiment may be formed through various methods such as a casting method, or the like.

Further, as described above, the base plate 50 according to the present embodiment has the sleeve 13 and the support plate 14 press-fitted to and fixedly coupled with the coupling hole 54 thereof. However, the present invention is not limited thereto. For example, the sleeve 13 and the support plate 14 are fixedly coupled by applying an adhesive (not shown) to the inner circumferential surface of the coupling hole 54.

Meanwhile, the base plate 50 according to the present embodiment may have a plurality of passive elements mounted thereon. Particularly, when an optical disc drive (not shown) using the motor 100 according to the present embodiment is implemented, a data receiving unit (not shown) receiving data from a disc ID mounted on the rotor 40 (or a chucking mechanism 48) to be described below may be included.

The circuit board 60 has a circuit pattern (not shown) formed thereon in order to apply power to the motor 100, and is electrically connected to a winding coil 36 of the rotor 40 to be described below to thereby apply power to the winding coil 36. In addition, a ground pattern of circuit patterns of the circuit board 60 may be formed to be conducted to the base plate 50. As the circuit board 60, various boards such as a general printed circuit board (PCB), a flexible PCB, or the like, may selectively be used as needed.

The stator 30 is a fixed structure including a core 32 and the winding coil 36 wound around the core 32.

The core 32 according to the present embodiment is formed by stacking a plurality of steel plates, and is formed to be radially extended in the outer diameter direction based on the shaft 11. The core 32 is press-fitted and fixedly coupled to the outer circumferential surface of the sleeve 13 so as to contact the outer circumferential surface of the sleeve 13.

The winding coil 36, wound around the core 32, generates electromagnetic force when power is applied thereto. The winding coil 36 according to the present embodiment is electrically connected to the circuit board 60 to thereby receive power from the circuit board 60.

In addition, the core 32 according to the present embodiment may have an attraction magnet 36 coupled to an upper surface thereof. The attraction magnet 36, which is formed as a permanent magnet and prevents the rotor 40 from being floated due to the rotational force of the rotor 40 when the rotor 40 rotates, attracts the rotor 40 using magnetic force.

The rotor 40 includes a magnet 42 and the rotor case 44.

The magnet 42 is a ring shaped permanent magnet generating a magnetic force having a predetermined strength by alternately magnetizing an N pole and an S pole thereof in a circumferential direction.

The rotor case 44 has a cup shape to thereby receive the stator 30 therein, and includes a rotor hub 45 and a magnet coupling part 46.

The rotor hub 45 is press-fitted and fixedly coupled to an upper end of the shaft 11, and is bent upwardly in the axial direction in order to maintain unmating force with the shaft 11. The rotor hub 45 has a chucking mechanism 48 coupled onto an outer circumferential surface thereof, wherein the chucking mechanism 48 may load a disc D.

The magnet coupling part 46, which has the magnet 42 coupled thereto, is formed along an inner circumferential surface of the rotor case 44. Here, the magnet 42 is disposed to face the core 32 having the winding coil 36 wound therearound. Therefore, when power is applied to the winding coil 36, the rotor 40 rotates due to electromagnetic interaction between the magnet 42 and the winding coil 36. The shaft 11 and the chucking mechanism 48 coupled to the rotor case 44 also rotate due to the rotation of the rotor 40.

In the motor according to the present embodiment configured as described above, the core 32 and the base plate 50 are directly fixedly coupled to the sleeve 13 without using the sleeve holder according to the related art. Therefore, the number of components of the motor 100 is reduced, whereby manufacturing costs may be reduced and a process may be simplified.

The motor 100 as described above is not limited to the above-mentioned embodiments, but various modifications may be made thereto.

FIGS. 2 through 4 are cross-sectional views schematically showing a motor according to another exemplary embodiment of the present invention.

A motor according to exemplary embodiments to be described below is configured to have a structure similar to that of the motor 100 (See FIG. 1) according to the above-mentioned embodiment and is different therefrom only in the shape of the sleeve contact part 52 formed on the base plate 50. Therefore, a detailed description of the same components will be omitted, and the sleeve contact part 52 will be mainly described in detail.

First, FIG. 2 shows a motor 200 in which the sleeve contact part 52 has a block shaped cross section. When the sleeve contact part 52 is formed to have a block shape as described above, it supports the core 32 through a wider contact surface, whereby the core may be more stably supported.

Meanwhile, the base plate 50 having the block shaped sleeve contact part 52 according to the present embodiment formed thereon may be manufactured through a casting method, or the like. However, the present invention is not limited thereto and may have various methods applied thereto. For example, the sleeve contact part 52 formed as an annular ring having the block cross section is separately prepared, and the base plate according to the related art and the sleeve contact part 52 are bonded to each other.

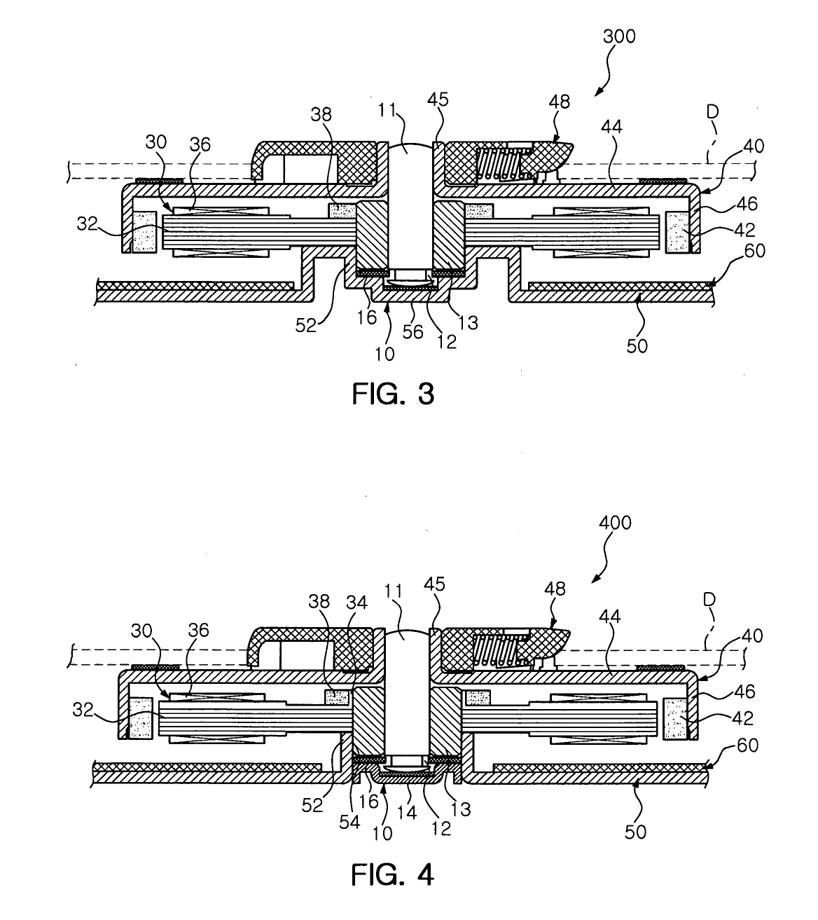

FIG. 3 shows a motor 300 in which the support plate 14 (See FIG. 1) according to the above-mentioned embodiment is omitted and the base plate 50 serves as the support plate 14 (See FIG. 1). In this case, instead of the coupling hole 54 (See FIG. 1) according to the above-mentioned embodiment, a support part 56 formed as a groove by the sleeve contact part 52 is formed in the base plate 50. The support part 56 serves as the support plate 14 (See FIG. 1) according to the above-mentioned embodiment. The base plate 50 according to the present embodiment may be formed through various processing processes such as a bending process, or the like. When the base plate 50 is formed to also serve as the support plate 14 (See FIG. 1) as described above, a coupling process between the base plate 50 and the support plate 14 (See FIG. 1) may be omitted, such that the motor may be more efficiently manufactured.

Meanwhile, a motor 400 shown in FIG. 4 is configured to have a structure similar to that of the motor 100 described in the above-mentioned embodiment of FIG. 1, and is different therefrom only in a coupling structure between the attraction magnet 38 and the core 32. Therefore, a detailed description of the same components will be omitted, and the coupling structure between the attraction magnet 38 and the core 32 will mainly be described in detail.

Referring to FIG. 4, the motor 400 according to the present embodiment includes an extension contact part 34 formed by at least one of steel plates forming the core 32.

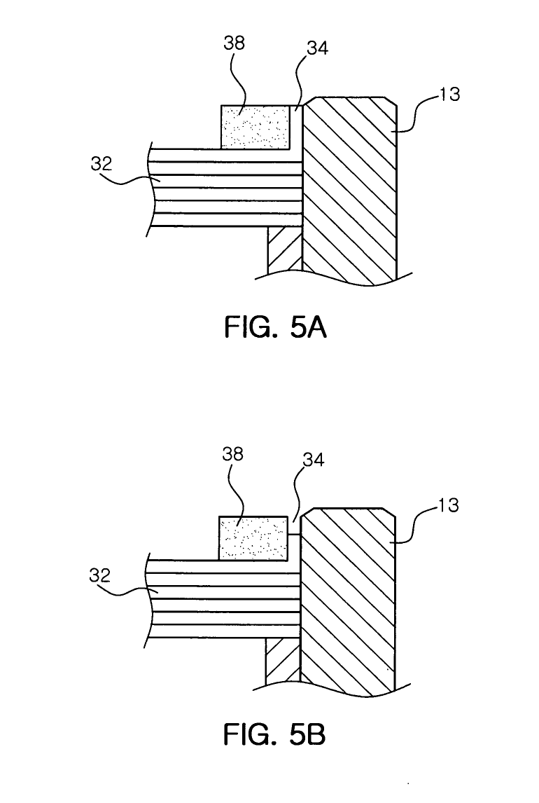

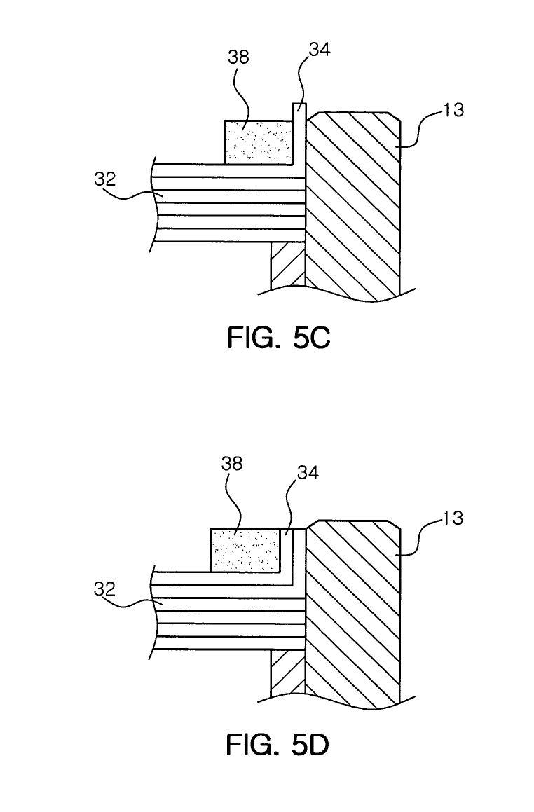

FIG. 5A is an enlarged view of the extension contact part of FIG. 4. Referring to FIGS. 4 and 5A, the extension contact part 34 according to the present embodiment is extended and bent so that a portion of the steel plate contacts the outer circumferential surface of the sleeve 13. The extension contact part 34 may be formed by extending the steel plate in a direction in which the sleeve 13 is disposed and then performing processing such as bending, or the like.

In addition, when the extension contact part 34 is formed as described in the present embodiment, the attraction magnet 38 is coupled to the extension contact part 34 along an outer circumferential surface thereof as shown in FIG. 4. Therefore, the attraction magnet 38 may be coupled only onto the core 32 without directly contacting the sleeve 13.

When the extension contact part 34 according to the present embodiment is formed as described above, a contact area between the core 32 and the sleeve 13 is increased. Therefore, the core 32 may be more stably fixed to the sleeve 13.

Meanwhile, FIG. 5A shows that the extension contact part 34 is protrudedly formed to have a height the same as that of the attraction magnet 38. However, the present invention is not limited thereto but may be variously applied as shown in FIGS. 5B and 5C.

FIGS. 5B through 5D are views showing extension contact parts according to other exemplary embodiments of the present invention. First, FIG. 5B shows a case in which the extension contact part 34 is protrudedly formed to have a height lower than that of the attraction magnet 38. In this case, a method of forming the extension contact part 34 so as to have a protrusion height lower than that of the attraction magnet 38, a method of forming the attraction magnet 38 so as to have a height higher than the protrusion height of the extension contact part 34, or the like, may be used.

In addition, FIG. 5C shows that the extension contact part 34 is protrudedly formed to have a height higher than that of the attraction magnet 38. In this case, a method of forming the extension contact part 34 so as to have a protrusion height higher than the height of the attraction magnet 38, a method of forming the attraction magnet 38 so as to have a height lower than the protrusion height of the extension contact part 34, or the like, may be used.

In addition, FIGS. 4 through 5C show that the extension contact part 34 is formed using only a single sheet of steel plate disposed at an uppermost layer among steel plates forming the core 32. However, the present invention is not limited thereto. As shown in FIG. 5D, the extension contact part 34 may be formed using two sheets of steel plates. In addition, the extension contact part 34 may be formed using various numbers of steel plates as needed.

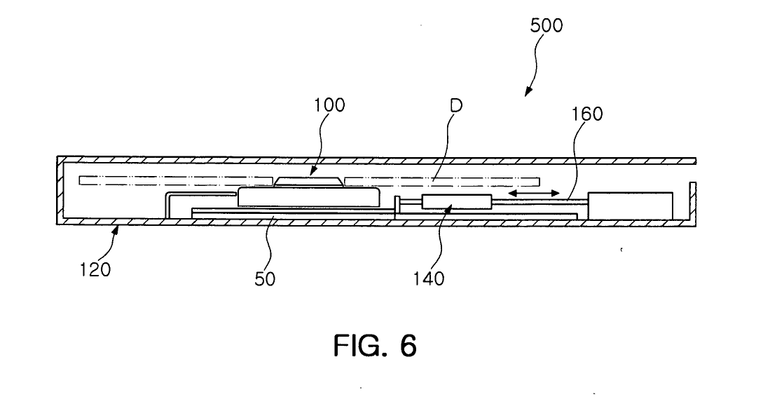

FIG. 6 is a schematic cross-sectional view showing an optical disc drive according to an exemplary embodiment of the present invention.

Referring to FIG. 6, an optical disc drive 500 according to the exemplary embodiment of the present embodiment includes the motor 100 according to the above-mentioned embodiment of FIG. 1 mounted therein. However, the present invention is not limited thereto. The optical disc drive 1 may include any one of the motors 100, 200, 300, and 400 according to the above-mentioned embodiments mounted therein.

The optical disc drive 500 according to the present embodiment may include a frame 120, an optical pickup mechanism 140 and a moving mechanism 160.

The frame 120 serves as a case of the optical disc drive 500, and has the base plate 50 of the motor 100 fixed to an inner portion thereof.

The optical pickup mechanism 140 is mounted to be movable in a space below a disc D loaded on the motor 100, and receives data from the disc D.

The moving mechanism 160 serves to transfer the optical pickup mechanism 140 in a diameter direction of the disc D to thereby receive data from the entire surface of the disc D.

As set forth above, with the motor and the optical disc drive using the same according to the exemplary embodiments of the present invention, the core and the base plate are directly fixed to the sleeve, such that the number of components of the motor is reduced, whereby a cost may be reduced and a process may be simplified.

Particularly, according to the related art, since the sleeve holder is used, each of the base plate and the support plate should be coupled to the sleeve holder. As a result, a coupling process may be performed twice. However, according to the present invention, the base plate and support plate may be coupled to each other through a single process only.

Therefore, pressure applied to the sleeve and the base plate during the coupling process may be minimized to reduce an influence on an axial vertical degree of the motor, whereby a process yield may be improved.

Meanwhile, the motor and the optical disc drive using the same according to the present invention is not limited to the above-mentioned embodiments, but various modifications may be made by those skilled in the art without departing from the spirit and scope of the present invention.

For example, the above-mentioned embodiment has described a case in which the extension contact part formed on the core is formed by bennding upwardly the steel plate disposed at the uppermost layer among steel plates forming the core.

However, the present invention is not limited thereto. For example, the extension contact part may be formed by bending downwardly the steel plate disposed at the lowermost layer (or a plurality of steel plates disposed at a lower portion of the core).

In addition, a case in which the motor is included in the optical disc drive has been described in the embodiment of the invention, the present invention is not limited thereto but may be variously applied to a motor including a sleeve, a base plate, and a core.

While the present invention has been shown and described in connection with the exemplary embodiments, it will be apparent to those skilled in the art that modifications and variations can be made without departing from the spirit and scope of the invention as defined by the appended claims.

What is claimed is:

1. A motor comprising:
a shaft;
a sleeve supporting the shaft so as to be rotatable;
a stator coupled to an outer circumferential surface of the sleeve and extended outwardly in an outer diameter direction of the sleeve; and
a base plate coupled to the outer circumferential surface of the sleeve under the stator and supporting the stator.

2. The motor of claim 1, wherein the base plate includes a sleeve contact part protruding upwardly along the outer circumferential surface of the sleeve and supporting the stator.

3. The motor of claim 2, further comprising a support plate supporting the shaft under the shaft,
wherein the support plate is press-fitted to the base plate to thereby be coupled thereto.

4. The motor of claim 3, wherein the support plate has an outer circumferential surface coupled to an inner circumferential surface of the sleeve contact part of the base plate.

5. The motor of claim 2, wherein the sleeve contact part has an L-shaped protruded cross section.

6. The motor of claim 2, wherein the sleeve contact part has a block shaped protruded cross section.

7. The motor of claim 2, wherein the base plate includes a support part supporting the shaft under the shaft, and
the support part is formed as a groove formed by the sleeve contact part.

8. The motor of claim 2, wherein the stator includes:
a core formed by stacking a plurality of steel plates, contacting the outer circumferential surface of the sleeve, and extended in the outer diameter direction of the sleeve; and
a winding coil wound around the core,
wherein the core includes an extension contact part being extended and bent so that at least one steel plate contacts the outer circumferential surface of the sleeve.

9. The motor of claim 8, wherein the extension contact part is formed using a steel plate disposed at an uppermost layer among the steel plates forming the core.

10. The motor of claim 8, further comprising a rotor receiving the stator and press-fitted to the shaft to thereby be fixed thereto; and
an attraction magnet coupled to an outer circumferential surface of the extension contact part and attracting the rotor using magnetic force.

11. The motor of claim 10, wherein the extension contact part has a height the same as that of the attraction magnet.

12. The motor of claim 10, wherein the extension contact part has a height lower than that of the attraction magnet.

13. The motor of claim 10, wherein the extension contact part has a height higher than that of the attraction magnet.

14. An optical disc drive comprising:
the motor of claim 1; and
an optical pickup mechanism mounted to be movable in a space below a disc loaded on the motor and receiving data from the disc.
